(19) United States
(12) Patent Application Publication
(10) Pub. No.: US 2013/0179770 A1
(43) Pub. Date: Jul. 11, 2013

(54) CREATING OPTIMAL INTERACTIVE ELEMENTS

(71) Applicant: James Kent, London (GB)

(72) Inventor: James Kent, London (GB)

(73) Assignee: Google Inc.

(21) Appl. No.: 13/348,561

(22) Filed: Jan. 11, 2012

(51) Int. Cl. G06F 17/30

(52) U.S. Cl. 715/234

(57) ABSTRACT

A method for improving a display element on a web page is disclosed. The display element is configured for a visitor to the web page to perform a specified action. The method includes determining a target industry to which the web page relates using an industry database. The method also includes generating replacement display elements using a template database. The replacement display elements are determined based on the target industry. The method also includes determining a predicted conversion rate for each the display elements, representing a likelihood that a visitor to the web page will perform the action specified by the display element. The method also includes generating an ordered list of replacement display elements based on the predicted conversion rates. The method also includes receiving a selection input from a user and selecting at least one of the replacement display elements from the ordered list.

### BACKGROUND

The present disclosure relates generally to optimizing a web page. The present disclosure more specifically relates to providing interactive elements for a web page that are optimized to improve the conversion rate of the web page.

Interactive elements on a web page, such as buttons and forms, may be activated by a user taking some action, such as clicking on the button with a mouse cursor or entering text into the form. Interacting with such elements may result in a conversion, meaning that the user reaches a goal of the web page, such as completing a purchase or signing up for a mailing list. The user also may interact with elements that take the user away from the goals of the web page, such as by navigating to another web page by clicking on an advertisement or other link.

### SUMMARY

Implementations of the systems and methods for improving a display element are described herein. One implementation is a method of improving an original display element on a web page. The original display element is configured for a visitor to the web page to perform a specified action on the web page. The method includes determining a target industry to which the web page relates using an industry database and generating a plurality of replacement display elements using a template database. The replacement display elements are determined based on the target industry. The method also includes determining a predicted conversion rate for each the display elements. The predicted conversion rate represents a likelihood that a visitor to the web page will perform the action specified by the display element. The method also includes generating an ordered list of replacement display elements based on the predicted conversion rates. The method also includes receiving a selection input from a user, selecting at least one of the replacement display elements from the ordered list.

This and other implementations can each optionally include one or more of the following features. The original display element may includes a color, and at least one replacement display element may include a color different from the color of the original display element. The replacement display element may includes a brand name associated with the web page. The original display element may include a button, and the replacement display element may include a button of a different size from the button of the original display element. The method also may include generating computer code implementing the selected replacement display element for the web-page. The method also may include analyzing the web page and the plurality of replacement display elements with a web page optimizer. The web page optimizer implements, independently of each other, the replacement display elements on the web page, and measures, for each replacement display element, a new conversion rate associated with the implementation of the replacement display element. The predicted conversion rates may be based on empirically observed conversion rates associated with the replacement display elements.

Another implementation is a computer-readable medium that stores machine instructions. The instructions may be executed by one or more processors to cause the one or more processors to perform operations. The operations include determining a target industry to which the web page relates using an industry database and generating a plurality of replacement display elements using a template database. The replacement display elements are determined based on the target industry. The operations also include determining a predicted conversion rate for each of the display elements, representing a likelihood that a visitor to the web page will perform the action specified by the display element. The operations also include generating an ordered list of replacement display elements based on the predicted conversion rates and receiving a selection input from a user. The selection input selects at least one of the replacement display elements from the ordered list.

Another implementation is a system for improving an original display element on a web page. The original display element is configured for a visitor to the web page to perform a specified action on the web page. The system includes a memory to store the web page and a communication interface. The communication interface is in communication with the memory and is configured to receive a plurality of replacement display elements from a template database. The system also includes a processor in communication with the memory and the communication interface. The processor is configured to determine a predicted conversion rate for each of the display elements. The predicted conversion rate represents a likelihood that a visitor to the web page will perform the action specified by the display element. The processor also is configured to generate an ordered list of replacement display elements based on the predicted conversion rates. The processor is also configured to receive a selection input from a user, selecting at least one of the replacement display elements from the ordered list.

Another implementation is a method of improving an original display element on a web page. The original display element is configured for a visitor to the web page to perform a specified action on the web page. The method includes generating a plurality of replacement display elements using a template database. The method also includes determining a predicted conversion rate for each of the display elements. The predicted conversion rate represents a likelihood that a visitor to the web page will perform the action specified by the display element. The method also includes generating an ordered list of replacement display elements based on the predicted conversion rates. The method also includes receiving a selection input from a user, selecting at least one of the replacement display elements from the ordered list.

These implementations are mentioned not to limit or define the scope of this disclosure, but to provide examples of implementations to aid in understanding thereof.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a block diagram of a computer system in accordance with a described implementation;

FIG. 2 is a diagram of a web page in accordance with a described implementation;

FIG. 3 is a diagram of the web page of FIG. 2, in which a display element has been changed to change a size of the display element;

FIG. 4 is a diagram of the web page of FIG. 2, in which a display element has been changed to change a location and color of the display element;

FIG. 5 is a diagram of the web page of FIG. 2, in which a display element has been changed to include a brand name relating to the web page;

FIG. 6 is a flow diagram of a process in accordance with a described implementation; and

FIG. 7 is a flow diagram of a process in accordance with a described implementation.

Like reference numbers and designations in the various drawings indicate like elements.

### DETAILED DESCRIPTION

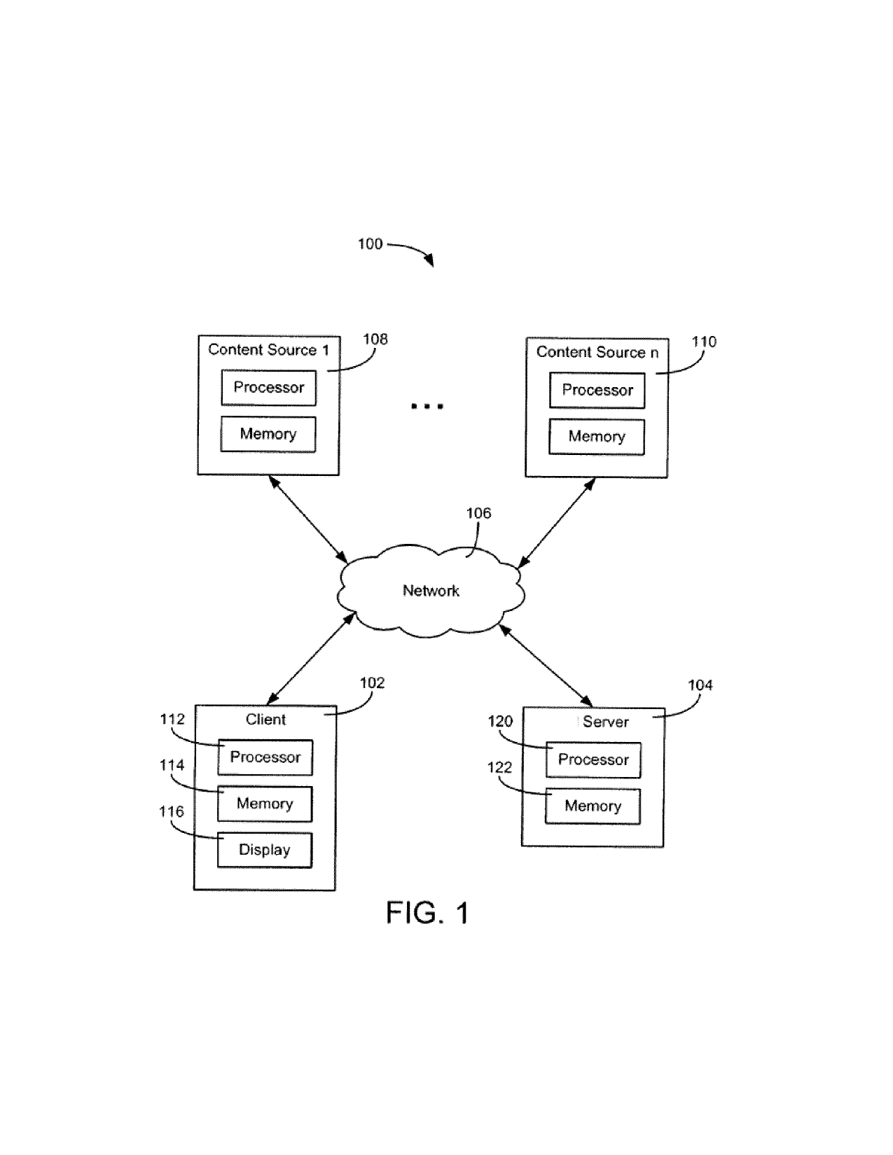

Referring to FIG. 1, a block diagram of a computer system 100 in accordance with a described implementation is shown. System 100 includes a client 102 which communicates with other computing devices via a network 106. For example, client 102 may communicate with one or more content sources ranging from a first content source 108 up to an nth content source 110. Content sources 108, 110 may provide webpages and/or media content (e.g., audio, video, and other forms of digital content) to client 102. System 100 may also include an analytics server 104, which may performs analytics on the webpages provided by content sources 1-n and also may provide content to be included in the webpages over network 106.

Network 106 may be any form of computer network that relays information between client 102, advertisement server 104, and content sources 108, 110. For example, network 106 may include the Internet and/or other types of data networks, such as a local area network (LAN), a wide area network (WAN), a cellular network, satellite network, or other types of data networks. Network 106 may also include any number of computing devices (e.g., computer, servers, routers, network switches, etc.) that are configured to receive and/or transmit data within network 106. Network 106 may further include any number of hardwired and/or wireless connections. For example, client 102 may communicate wirelessly (e.g., via WiFi, cellular, radio, etc.) with a transceiver that is hardwired (e.g., via a fiber optic cable, a CATS cable, etc.) to other computing devices in network 106.

Client 102 may be any number of different user electronic devices configured to communicate via network 106 (e.g., a laptop computer, a desktop computer, a tablet computer, a smartphone, a digital video recorder, a set-top box for a television, a video game console, etc.). Client 102 is shown to include a processor 112 and a memory 114, i.e., a processing circuit. Memory 114 stores machine instructions that, when executed by processor 112, cause processor 112 to perform one or more of the operations described herein. Processor 112 may include a microprocessor, application-specific integrated circuit (ASIC), field-programmable gate array (FPGA), etc., or combinations thereof. Memory 114 may include, but is not limited to, electronic, optical, magnetic, or any other storage or transmission device capable of providing processor 112 with program instructions. Memory 114 may further include a floppy disk, CD-ROM, DVD, magnetic disk, memory chip, ASIC, FPGA, read-only memory (ROM), random-access memory (RAM), electrically-erasable ROM (EEPROM), erasable-programmable ROM (EPROM), flash memory, optical media, or any other suitable memory from which processor 112 can read instructions. The instructions may include code from any suitable computer-programming language such as, but not limited to, C, C++, C#, Java, JavaScript, Perl, Python and Visual Basic.

Client 102 may also include one or more user interface devices. In general, a user interface device refers to any electronic device that conveys data to a user by generating sensory information (e.g., a visualization on a display, one or more sounds, etc.) and/or converts received sensory information from a user into electronic signals (e.g., a keyboard, a mouse, a pointing device, a touch screen display, a microphone, etc.). The one or more user interface devices may be internal to a housing of client 102 (e.g., a built-in display, microphone, etc.) or external to the housing of client 102 (e.g., a monitor connected to client 102, a speaker connected to client 102, etc.), according to various implementations. For example, client 102 may include an electronic display 116, which visually displays webpages using webpage data received from content sources 108, 110 and/or from advertisement server 104.

Content sources 108, 110 are electronic devices connected to network 106 and provide media content to client 102. For example, content sources 108, 110 may be computer servers (e.g., FTP servers, file sharing servers, web servers, etc.) or other devices that include a processing circuit. Media content may include, but is not limited to, webpage data, a movie, a sound file, pictures, and other forms of data. Similarly, analytics server 104 may include a processing circuit including a processor 120 and a memory 122. In some implementations, analytics server 104 may include several computing devices (e.g., a data center, a network of servers, etc.). In such a case, the various devices of analytics server 104 may be in electronic communication, thereby also forming a processing circuit (e.g., processor 120 includes the collective processors of the devices and memory 122 includes the collective memories of the devices).

Analytics server 104 may provide content to client 102 via network 106. For example, content source 108 may provide a webpage to client 102, in response to receiving a request for a webpage from client 102. In some implementations, content from analytics server 104 may be provided to client 102 indirectly. For example, content source 108 may receive content from analytics server 104 and use the content as part of the webpage data provided to client 102. In other implementations, content from analytics server 104 may be provided to client 102 directly. For example, content source 108 may provide webpage data to client 102 that includes a command to retrieve content from analytics server 104. On receipt of the webpage data, client 102 may retrieve content from analytics server 104 based on the command and display the content when the webpage is rendered on display 116.

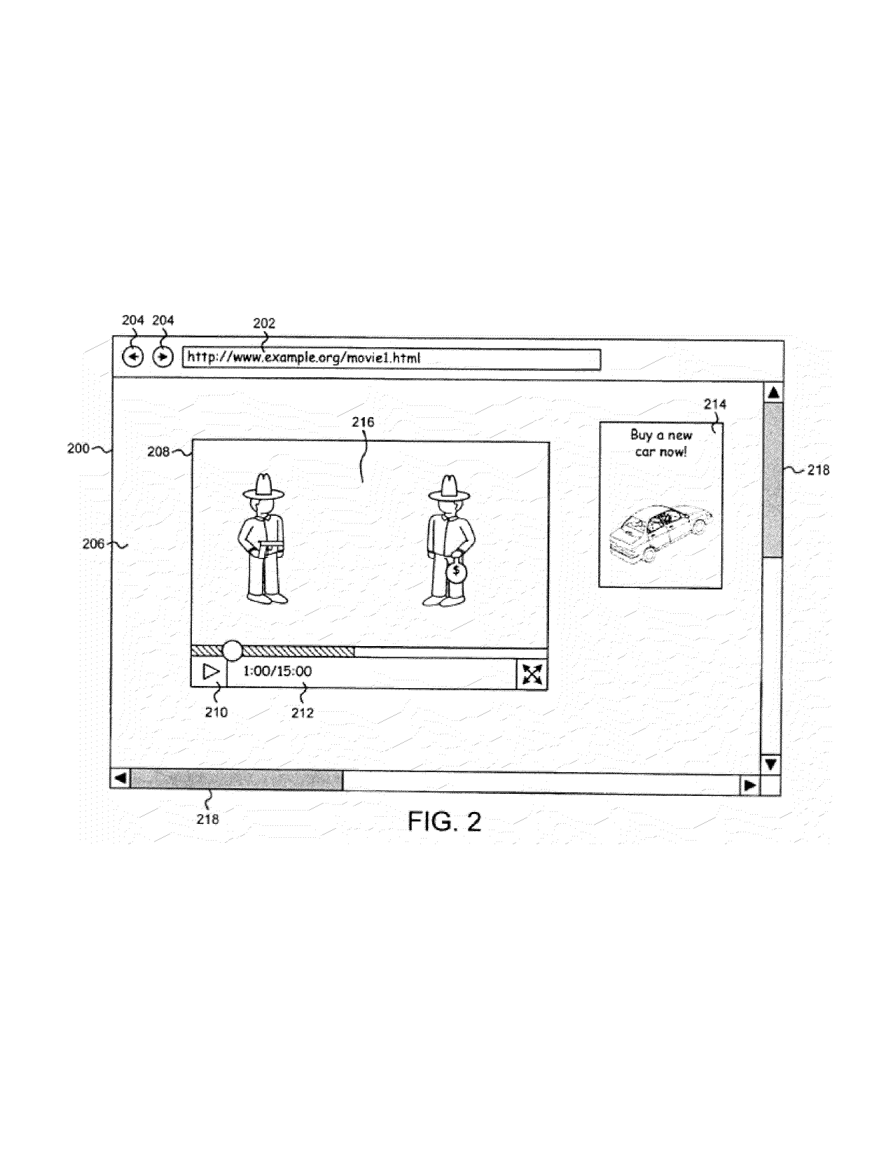

As shown in FIG. 2, the one or more processors in communication with display 200 may execute a web browser application (e.g., display 200 is part of a client device). The web browser application operates by receiving input of a uniform resource locator (URL) into a field 202, such as a web address, from an input device (e.g., a pointing device, a keyboard, a touchscreen, or another form of input device). In response, one or more processors executing the web browser may request data from a content source corresponding to the URL via a network (e.g., the Internet, an intranet, or the like). The content source may then provide webpage data and/or other data to the client device, which causes visual indicia to be displayed by display 200.

In general, webpage data may include text, hyperlinks, layout information, and other data that is used to provide the framework for the visual layout of displayed webpage 206. In some implementations, webpage data may be one or more files of webpage code written in a markup language, such as the hypertext markup language (HTML), extensible HTML (XHTML), extensible markup language (XML), or any other markup language. For example, the webpage data in FIG. 2 may include a file, “movie1.html” provided by the website, “www.example.org.” The webpage data may include data that specifies where indicia appear on webpage 206, such as movie 216 or other visual objects. In some implementations, the webpage data may also include additional URL information used by the client device to retrieve additional indicia displayed on webpage 206. For example, the file, “movie1.html,” may also include one or more tags used to retrieve an interactive display element 214 from a remote location (e.g., the analytics server, the content source that provides webpage 206, etc.) and to display the interactive display element 214 on display 200.

A website may include a number of different webpages. In some cases, a website will have one or more “goals,” which may be webpages that are reached when a visitor to the website performs an action that the website seeks to encourage, or otherwise defines as a goal. Generally speaking, this means that the visitor to the website does something that serves the interests of the organization that owns the website. For example, an e-commerce website may have one or more goal webpages that are reached when a sale is completed. Such webpages often simply display a message thanking the customer for the business and indicating that the transaction was completed successfully. In the case of a website belonging to a social organization, on the other hand, a goal may include providing personal information, such as email and mailing addresses and phone numbers, and signing up to receive communications from the organization. In such a case also, a goal webpage may provide a confirmation to the visitor that the information was received, and customary message of thanks.

When a visitor to a website navigates to a goal webpage, this may be referred to as a “conversion.” However, not every visitor to a website will result in a conversion. For example, not every visitor to an e-commerce website will buy something or otherwise meet a criterion predefined to represent a conversion. There are various reasons for this. Some visitors may come to the website to browse, and decide that the prices are too high. Other visitors may not find the products they are seeking Still other visitors may simply be browsing or may have reached the website by mistake.

Some visits, however, will fail to result in a conversion at least in part because of a flaw in the design of the website. When a flaw in the design of a webpage at the website results in a failed conversion, the organization that owns the website suffers a lost opportunity—lost customers, lost money, fewer members of a mailing list, etc.

The design of a webpage generally includes a number of display elements, such as a background, images, text, buttons, links, forms, embedded content, and so on. Changes in the organization and presentation of these elements can have measurable effects on conversion rates. For example, one way in which a conversion commonly is reached is through a “call-to-action”—e.g., a message to the visitor to “click here now!” or “press this button to checkout.” Often a call-to-action is implemented as a button, although other implementations are possible, such as links, forms, or any other display element that is interactive, such that a visitor to the web page can interact with the element by clicking on it, hovering over it, entering text into a field, etc.

Various inefficiencies in display elements, such as calls-to-action, may reduce conversion rates. In some cases, elements may be implemented in inefficient sizes. In FIG. 2, for example, interactive display element 214 may be a call-to-action seeking a conversion by convincing a visitor to the webpage to click on the element 214, and thus being presented information about how to “Buy a new car now!” In this simplified example, two different elements are presented on the webpage, namely interactive display element 214 and a movie element 216. The movie element 216 is significantly larger than the interactive display element 214, and thus the movie will likely grab the attention of a visitor to the web page better than the smaller interactive display element 214.

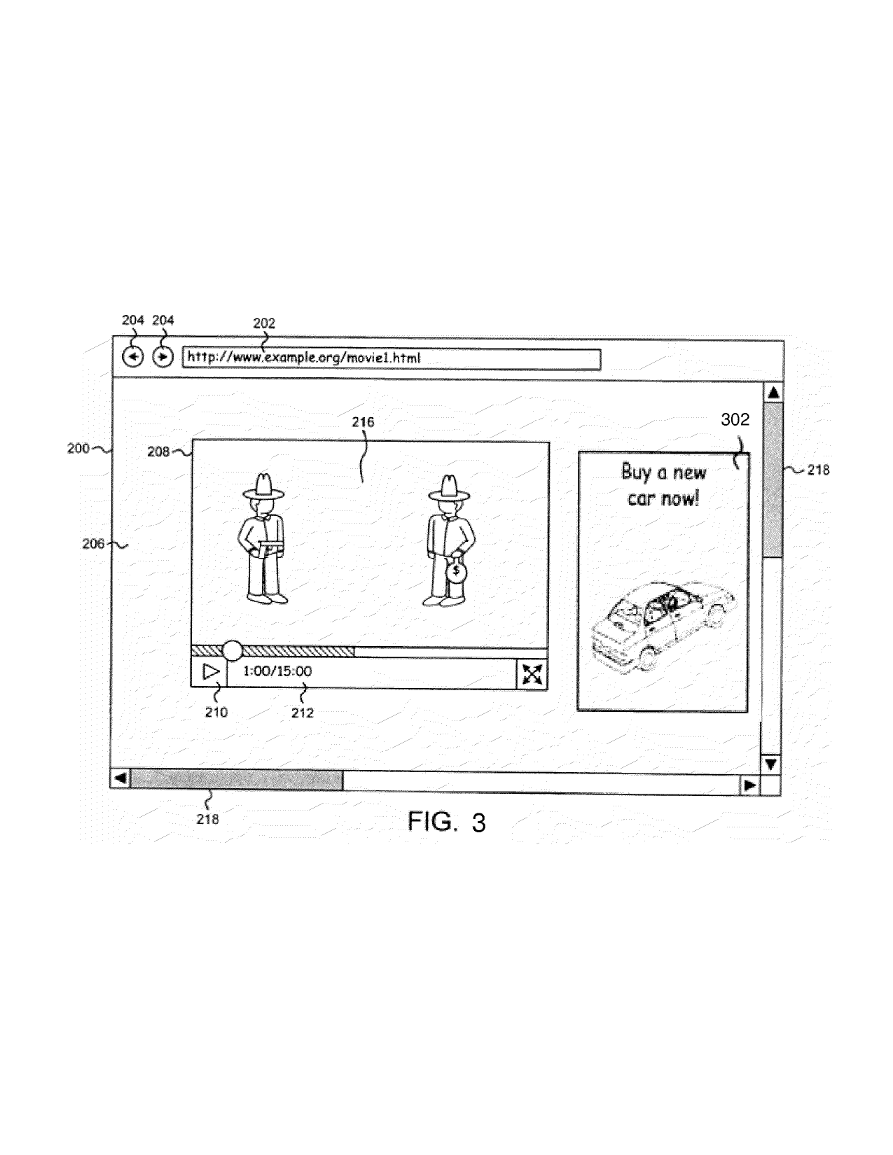

FIG. 3 is a diagram of the web page of FIG. 2, in which the interactive display element 214 has been replaced with a larger interactive display element 302. The size and prominence of the interactive display element 302 relative to the movie element 216 is now increased, and the likelihood that visitors to the web page will be distracted by the movie, and perhaps fail to notice or forget about buying a car, is similarly reduced.

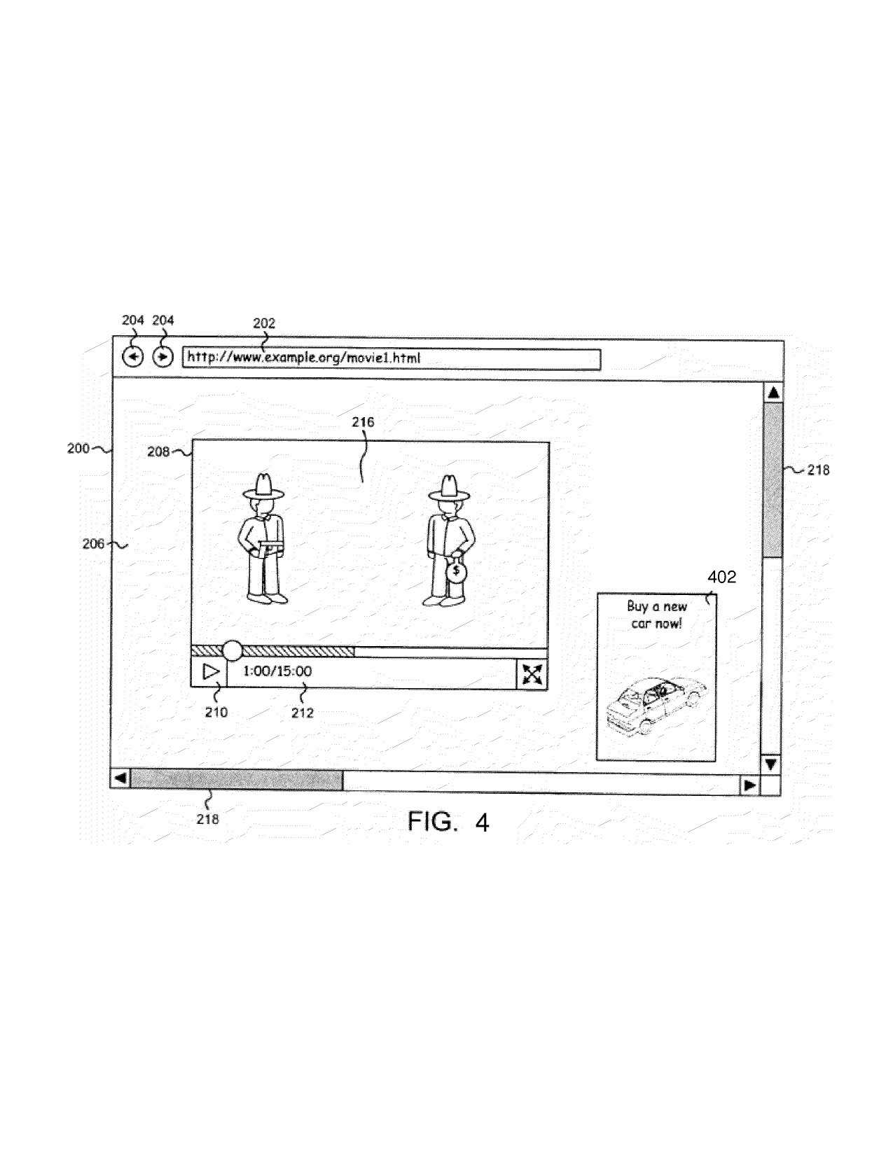

In some cases, certain layouts of display elements have been found to be more likely to result in a conversion than others. Accordingly, simply rearranging the display elements, possibly by moving even a single element (such as a button implementing a call-to-action), the expected conversion rate may be improved. FIG. 4 is a diagram of the web page of FIG. 2, in which the interactive display element 214 has been replaced with an interactive display element 402 in a new location. A color of the interactive display element 402 also may be a different color. Certain colors may have different effects on the moods and actions of people viewing them. Furthermore, the color of a display element may make the display element difficult to see if the color is too similar to a background color of the web page. Such factors may be considered in optimizing a color of an interactive display element.

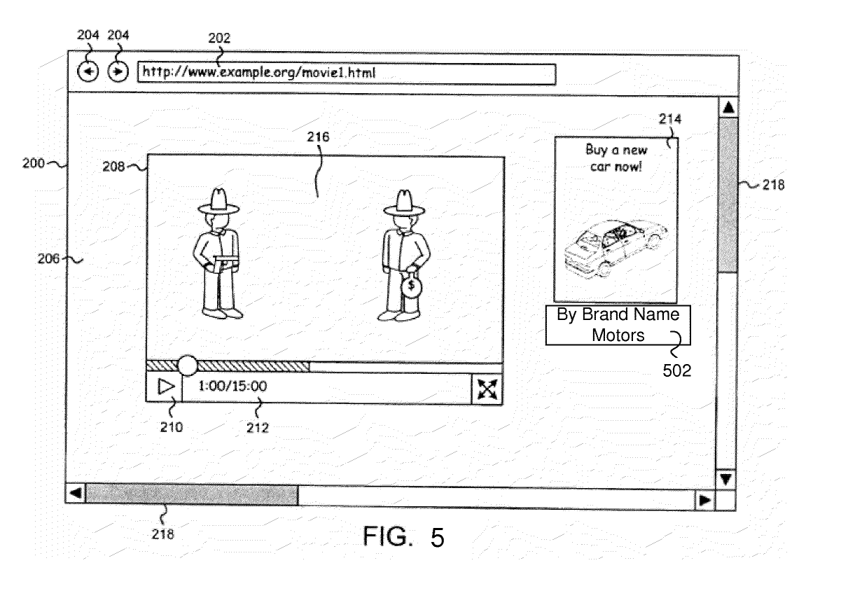

In some cases, a web page including interactive display elements may be made more attention-grabbing (and thus more likely to produce a conversion) by including certain familiar images, logos, trademarks, brand names, and the like. A potential customer may be less influenced by a generic message, such as, “Buy a new car now!” and more influenced if the customer also sees something reminding the customer of a well-known brand. FIG. 5 is a diagram of the web page of FIG. 2, in which the interactive display element 214 has been changed to include a brand name 502. Upon seeing the brand name 502, the potential customer may be reminded, for example, of the numerous advertisements s/he has seen and/or heard previously, from any number of sources such as TV, radio, print advertisements, and other internet advertisements.

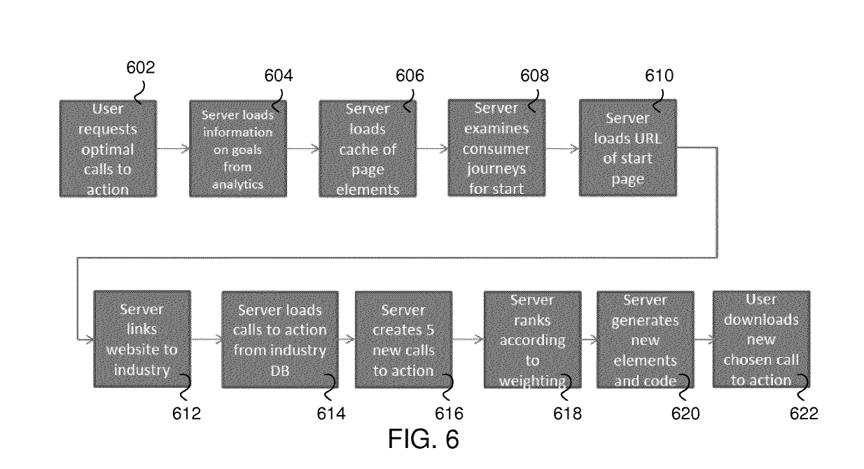

A process in accordance with a described implementation is now described with reference to FIG. 6. The process begins at block 602 where a user requests optimal calls-to-action for a website. The user may be an administrator or operator of the website. The request may be sent to and processed by the analytics server 104 in FIG. 1. The process continues at block 604, where the analytics server loads information on goals from analytics of the website. This information includes at least one goal webpage of the website to which the user hopes to drive as many visits as possible. Such goals often include landing pages that are loaded to confirm completion of a transaction such as a sale on an e-commerce website, or a “thank you” page in response to a visitor to the web page providing personal information, joining a mailing list, providing a charitable pledge, etc. The analytics server will use the information on these goals to optimize display elements of at least one webpage at the website, for the purpose of increasing conversion rates representing the proportion of visitors to the website and its constituent pages who reach a goal.

The process continues at block 606, where the analytics server retrieves display elements of a webpage to be analyzed and optimized. The display elements may be retrieved from a cached version of the webpage. In an alternative implementation, the analytics server may load the webpage directly, as a visitor to the webpage might. Such an implementation may have the disadvantage of being slower and requiring the response of one or more content sources (see elements 108 and 110 in FIG. 1), as well as content from the analytics server itself. An advantage, however, is that such an approach reduces the probability that the optimized display elements will reflect any changes that may have been implemented at the content servers since the last time the display elements were cached.

The process continues at block 608, where the analytics server analyzes the navigation paths through the website that a visitor to the website (e.g., a customer) may take to reach the webpage that is being optimized. Analyzing these paths allows the analytics server to determine candidate webpages for optimization and to determine interactive display elements that appear in webpages along the navigation paths that are most likely to yield improvements to conversion rates if optimized. This analysis may optionally include information about expected conversion rates and changes to conversion rates as discussed below with reference to block 618.

The process continues at block 610, where the analytics server loads the URL of a start page of the website. The start page of the website may then be used at block 612 to determine one or more industries to which the website belongs. The start page may be used because conventionally a start page of a website will concentrate more on communicating general notions of who, what, where, etc. the website deals with, while other webpages of the website may be more concerned with providing specific content that may less effectively provide a general, big-picture view of the website. Thus, the start page of the website will often be the best webpage of the website for determining the industry of the website.

The website industry may be determined by various other techniques. For example, the name of the company operating the website may be found in a database indexing businesses by industry. Alternatively, the source code of the website may include one or more tags providing information relating to the industry to which the website belongs. According to other implementations, the industry may be determined by analyzing text and other display elements on the start webpage for keywords, key phrases, common themes, etc. that serve to identify the industry. For example, a website which contains multiple mentions of keywords such as “stocks,” “401(k),” “financial advisor,” and the like probably can be classified as belonging to the investment industry. A website which contains keywords such as “car rental,” “reservation,” “hotel,” “flights,” and the like probably can be classified as belonging to the travel industry.

The information regarding the industry of the website is then used at block 614 where the analytics server retrieves template calls-to-action and/or other interactive display elements from a database containing various display elements indexed according to the industries in which they have been or may be used. For example, the database for the travel industry may include interactive display elements such as calendar elements for indicating dates of travel, car rental, or hotel stays, buttons that read “Book Now!,” and buttons that read “Click Here to Find a Flight.”

The process continues at block 616, where the analytics server generates one or more new interactive display elements. In the illustrated embodiment, five calls-to-action are generated. While any number of new elements is possible, and in principle there is no limit to the number of possibilities being considered, the number of results selected from the universe of possibilities by the server to be presented to a human administrator may in practice be limited by factors such as the ability of the administrator to review and evaluate the new elements, and a number between, e.g., one and ten elements may be chosen.

The process continues at block 618, where the analytics server ranks the selected results according to a metric and provides the results to the user. The metric may represent an absolute or relative conversion rate or change in conversion rate that the selected interactive display element, if implemented in the webpage, will realize from visitors to the webpage interactive with the display element. Such metrics may be provided according to various techniques. For example, calls-to-action and other interactive display elements may be observed in action as implemented in various websites and analytics data may be collected regarding, inter alia, conversion rates realized with the various interactive display elements. Algorithms also may be provided that use, e.g., rules-based analysis. The rules may themselves be based on empirical study. For example, an expected difference between using blue text or black text on a white background may be an X % difference in conversion rate (where X is the value that has been established by empirical study), while white text on a white background may be observed to result in a different value (likely a near zero conversion rate). In some implementations, the elements may also be ranked according to metrics such as size of the display element, distance of the element from other specified display elements, contrast of the display element relative to other display elements (such as the background), empirically observed or theoretically derived effectiveness of the display element, a weighted combination of any of the above, or a measure of uniqueness of the display element.

Once the candidate new interactive display elements have been selected and ranked, they may be presented to the user. In some implementations, the list of interactive display elements may be provided with the metric information used at block 618, while in other implementations such information may be hidden from the user. If there are large differences between the expected results of the different interactive display elements it may be beneficial for the user to have this knowledge. On the other hand, if the expected differences are relatively minor and speculative (because the expected conversion rates are predictions but are not certain to be realized), it may be more useful to provide the list without distracting the user with the metric information that was used to generate the list. In such an implementation, the user would be able to decide based on aesthetics, intuition, and other qualitative factors which approach to take optimizing the interactive display elements.

The process continues at block 620, where the analytics server generates computer code to implement the new interactive display elements. According to some implementations, the analytics server may generate computer code for implementing each of the candidate new interactive display elements, allowing the user to download any of the generated code as chosen. According to other implementations, the analytics server may receive a selection input from the user indicating which of the candidate new interactive display elements is to be implemented, and may then only generate the computer code to implement the selected interactive display element. According to yet further implementations, the analytics server may automatically select a new interactive display element to implement, based on, e.g., the metrics determined previously.

The process continues at block 622, where the user downloads the new interactive display element to be implemented. In some implementations, if the new interactive display element is selected automatically (without a user input to select which to implement), the new interactive display element may be downloaded automatically from the analytics server without user interaction. The new interactive display element may then be stored, e.g., on one of the content sources 108 and 110 of FIG. 1, along with the other code implementing the webpages of the website. Once the code has been downloaded and used to implement the new interactive display element, the website can begin to present visitors to the updated webpage(s) the new version of the webpage including the new interactive display element.

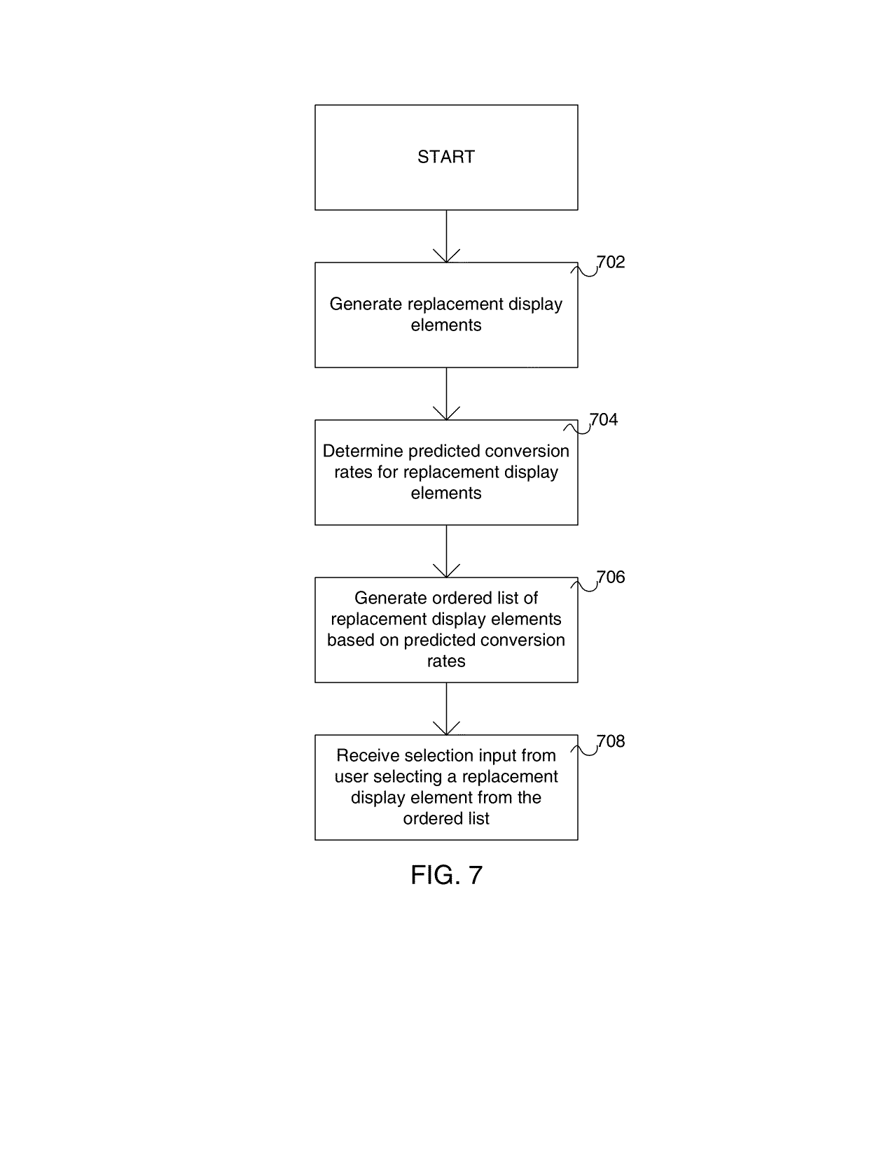

Similarly to FIG. 6, FIG. 7 is a flow diagram of a process in accordance with a described implementation. The process begins at block 702, at which the analytics server generates replacement display elements. The process then continues at block 704, where the analytics server determines predicted conversion rates for the replacement display elements. The process then continues at block 706 where the analytics server generates an ordered list of replacement display elements based on the predicted conversion rates. The process then continues at block 708, where the analytics server receives a selection input from the user selecting a replacement display element from the ordered list.

Implementations of the subject matter and the operations described in this specification have been described in the context of display elements on web pages, but other implementations are contemplated as well. For example, display elements for use in automated kiosks where users may purchase train tickets, movie tickets, exchange currency, etc. also may be analyzed and selected according to the principles disclosed herein. Similarly, these principles may be applied to Automated Teller Machines (ATMs) and other computer terminal based applications.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs embodied in a tangible medium, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium may be tangible and non-transitory.

The operations described in this specification can be implemented as operations performed by a data processing apparatus or processing circuit on data stored on one or more computer-readable storage devices or received from other sources.

The term “client or “server” include all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA or an ASIC. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors or processing circuits executing one or more computer programs to perform actions by operating on input data and generating output. The processes and logic flows can also be performed by, and apparatus can also be implemented as, special purpose logic circuitry, e.g., an FPGA or an ASIC.

Processors or processing circuits suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), OLED (organic light emitting diode), TFT (thin-film transistor), plasma, other flexible configuration, or any other monitor for displaying information to the user and a keyboard, a pointing device, e.g., a mouse, trackball, etc., or a touch screen, touch pad, etc., by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method of improving a display element on a web page, the display element configured for a visitor to the web page to perform a specified action on the web page, the method comprising:
determining, using an industry database, a target industry to which the web page relates;
generating, using a template database, a plurality of replacement display elements, wherein the replacement display elements are determined based on the target industry;
determining, for each of the replacement display elements, a predicted conversion rate for the display elements, the predicted conversion rate representing a likelihood that a visitor to the web page will perform the action specified by the display element;
generating, based on the predicted conversion rates, an ordered list of replacement display elements; and
receiving, from a user, a selection input, the selection input selecting at least one of the replacement display elements from the ordered list.

2. A method according to claim 1, wherein the display element includes a color, and wherein at least one replacement display element includes a color different from the color of the display element.

3. A method according to claim 1, wherein the replacement display element includes a brand name associated with the web page.

4. A method according to claim 1, wherein the display element includes a button having a size, and wherein the selected replacement display element includes a button having a size different from the size of the button of the display element.

5. A method according to claim 1, further including generating computer code implementing the selected replacement display element for the web-page.

6. A method according to claim 1, further including analyzing the web page and the plurality of replacement display elements with a web page optimizer, wherein the web page optimizer implements, independently of each other, the replacement display elements on the web page, and measures, for each replacement display element, a new conversion rate associated with the implementation of the replacement display element.

7. A method according to claim 1, wherein the predicted conversion rates are based on empirically observed conversion rates associated with the replacement display elements.

8. A computer-readable medium having machine instructions stored therein, the instructions being executable by one or more processors to cause the one or more processors to perform operations comprising:
determining, using an industry database, a target industry to which the web page relates;
generating, using a template database, a plurality of replacement display elements, wherein the replacement display elements are determined based on the target industry;
determining, for each of the replacement display elements, a predicted conversion rate for the display elements, the predicted conversion rate representing a likelihood that a visitor to the web page will perform the action specified by the display element;
generating, based on the predicted conversion rates, an ordered list of replacement display elements; and
receiving, from a user, a selection input, the selection input selecting at least one of the replacement display elements from the ordered list.

9. A computer-readable medium according to claim 8, wherein the display element includes a color, and wherein at least one replacement display element includes a color different from the color of the display element.

10. A computer-readable medium according to claim 8, wherein the replacement display element includes a brand name associated with the web page.

11. A computer-readable medium according to claim 8, wherein the display element includes a button having a size, and wherein the replacement display element includes a button having a size different from the size of the button of the display element.

12. A computer-readable medium according to claim 8, wherein the operations further comprise generating computer code implementing the selected replacement display element for the web-page.

13. A computer-readable medium according to claim 8, wherein the operations further include analyzing the web page and the plurality of replacement display elements with a web page optimizer, wherein the web page optimizer implements, independently of each other, the replacement display elements on the web page, and measures, for each replacement display element, a new conversion rate associated with the implementation of the replacement display element.

14. A computer-readable medium according to claim 8, wherein the predicted conversion rates are based on empirically observed conversion rates associated with the replacement display elements.

15. A system for improving a display element on a web page, the display element configured for a visitor to the web page to perform a specified action on the web page, the system comprising:
a memory to store the web page;
a communication interface, in communication with the memory and configured to receive, from a template database, a plurality of replacement display elements; and
a processor, in communication with the memory and the communication interface and configured to:
determine, for each of the replacement display elements, a predicted conversion rate for the display elements, the predicted conversion rate representing a likelihood that a visitor to the web page will perform the action specified by the display element; and
generate, based on the predicted conversion rates, an ordered list of replacement display elements.

16. A system according to claim 15, wherein the processor is further configured to receive, from a user, a selection input, the selection input selecting at least one of the replacement display elements from the ordered list.

17. A system according to claim 15, wherein the display element includes a color, and wherein at least one replacement display element includes a color different from the color of the display element.

18. A system according to claim 15, wherein the replacement display element includes a brand name associated with the web page.

19. A system according to claim 15, wherein the display element includes a button having a size, and wherein the replacement display element includes a button having a size different from the size of the button of the display element.

20. A system according to claim 15, wherein the processor is further configured to generate computer code implementing the selected replacement display element for the web-page.

21. A system according to claim 15, wherein the processor is further configured to analyze the web page and the plurality of replacement display elements with a web page optimizer, wherein the web page optimizer implements, independently of each other, the replacement display elements on the web page, and measures, for each replacement display element, a new conversion rate associated with the implementation of the replacement display element.

22. A system according to claim 15, wherein the predicted conversion rates are based on empirically observed conversion rates associated with the replacement display elements.

23. A method of improving a display element on a web page, the display element configured for a visitor to the web page to perform a specified action on the web page, the method comprising:
generating, using a template database, a plurality of replacement display elements;
determining, for each of the replacement display elements, a predicted conversion rate for the display elements, the predicted conversion rate representing a likelihood that a visitor to the web page will perform the action specified by the display element; and
generating, based on the predicted conversion rates, an ordered list of replacement display elements.

24. A method according to claim 23, further comprising receiving, from a user, a selection input, the selection input selecting at least one of the replacement display elements from the ordered list.
